(19) United States
(12) Patent Application Publication
(10) Pub. No.: US 2012/0218209 A1
(43) Pub. Date: Aug. 30, 2012

(54) INFORMATION PROCESSING DEVICE, METHOD OF CONTROLLING AN INFORMATION PROCESSING DEVICE, AND INFORMATION STORAGE MEDIUM

(75) Inventor: Tetsuro ITAMI, Setagaya-ku (JP)

(73) Assignee: KONAMI DIGITAL ENTERTAINMENT CO., LTD., Tokyo (JP)

(21) Appl. No.: 13/405,541

(22) Filed: Feb. 27, 2012

(30) Foreign Application Priority Data
Feb. 28, 2011 (JP) 2011-042499

(51) Int. Cl. G06F 3/041

(52) U.S. Cl. 345/173

(57) ABSTRACT

A determination unit executes determination on whether or not a target area, which is set based on one of a plurality of contact points where a user has touched a touch panel and which includes the one of the plurality of contact points, includes any other contact point out of the plurality of contact points. If the target area includes the any other contact point, a setting unit sets, as a new target area, an area that includes an area other than an area formerly set as the target area and that includes the one the plurality of contact points and the any other contact point. If the determination unit executes the determination multiple times, processing is executed based on the one of the plurality of contact points and on each contact point determined as being included in the target area.

### CROSS-REFERENCE TO RELATED APPLICATION

The present application claims priority from Japanese application JP 2011-042499 filed on Feb. 28, 2011, the content of which is hereby incorporated by reference into this application.

### BACKGROUND OF THE INVENTION

1. Field of the Invention

The present invention relates to an information processing device, a method of controlling an information processing device, and an information storage medium.

2. Description of the Related Art

Information processing devices including a touch panel are known. JP 2010-233832 A, for example, discloses a game machine for running a game, which is played with the use of a touch panel.

### SUMMARY OF THE INVENTION

Some information processing devices among those described above are capable of detecting a plurality of contact points where a user has touched the touch panel. An information processing device of this type may be required to execute processing based on a plurality of points touched by a single finger, and to implement this processing, the information processing device needs to identify a plurality of points touched by a single finger.

The present invention has been made in view of the problem described above, and an object of the present invention is therefore to provide an information processing device, a method of controlling an information processing device, and an information storage medium which are capable of appropriately identifying a plurality of points touched by a single finger.

In order to solve the above-mentioned problem, according to the present invention, there is provided an information processing device, including: a touch panel; detection unit configured to detect a plurality of contact points where a user has touched the touch panel; determination unit configured to execute determination on whether or not a target area, which is set based on one of the plurality of contact points and which includes the one of the plurality of contact points, includes any other contact point out of the plurality of contact points; setting unit configured to set, in the case where the determination unit determines that the target area includes the any other contact point, an area that includes an area other than an area formerly set as the target area and that includes the one of the plurality of contact points and the any other contact point, as a new target area based on the one of the plurality of contact points; and processing executing unit configured to execute, in the case where the determination unit executes the determination multiple times, processing based on the one of the plurality of contact points and on each contact point determined as being included in the target area in the determination executed multiple times.

According to the present invention, there is also provided a method of controlling an information processing device which includes a touch panel and which detects a plurality of contact points where a user has touched the touch panel, the method comprising: executing determination on whether or not a target area, which is set based on one of the plurality of contact points and which includes the one of the plurality of contact points, includes any other contact point out of the plurality of contact points; setting, in the case where it is determined in the determination that the target area includes the any other contact point, an area that includes an area other than an area formerly set as the target area and that includes the one of the plurality of contact points and the any other contact point, as a new target area based on the one of the plurality of contact points; and executing, in the case where the determination is executed multiple times, processing based on the one of the plurality of contact points and on each contact point determined as being included in the target area in the determination executed multiple times.

According to the present invention, there is also provided a program for causing a computer, which includes a touch panel and which detects a plurality of contact points where a user has touched the touch panel, to function as: determination unit configured to execute determination on whether or not a target area, which is set based on one of the plurality of contact points and which includes the one of the plurality of contact points, includes any other contact point out of the plurality of contact points; setting unit configured to set, in the case where the determination unit determines that the target area includes the any other contact point, an area that includes an area other than an area formerly set as the target area and that includes the one of the plurality of contact points and the any other contact point, as a new target area based on the one of the plurality of contact points; and processing executing unit configured to execute, in the case where the determination unit executes the determination multiple times, processing based on the one of the plurality of contact points and on each contact point determined as being included in the target area in the determination executed multiple times.

According to the present invention, there is also provided a non-transitory computer readable information storage medium storing the above-mentioned program.

According to the present invention, it is possible to appropriately identify a plurality of points touched by a single finger.

According to an aspect of the present invention, the determination unit may determine whether or not a target area which is equal to or less than a reference distance from the one of the plurality of contact points includes the any other contact point, and in the case where the determination unit determines that the target area includes the any other contact point, the setting unit may set the new target area by setting, as a new reference distance, a distance longer than the reference distance for the target area.

According to another aspect of the present invention, the detection unit may be capable of detecting as many contact points as a given upper limit number, the information processing device may include: unit configured to store, in a storage, in the case where the determination unit determines that the target area includes the any other contact point, the any other contact point determined as being included in the target area; and unit configured to control, in the case where the determination unit determines that the target area includes the any other contact point, the detection unit to detect a new contact point in place of the any other contact point determined as being included in the target area, and the processing executing unit may execute the processing based on the any other contact point determined as being included in the target area, which is stored in the storage.

According to still another aspect of the present invention, the information processing device may further include unit configured to obtain information about a length of the user's finger, and the target area may have a size controlled based on the information about the length of the user's finger.

According to yet another aspect of the present invention, the information processing device may further include unit configured to obtain information about a length of the user's finger, and an upper limit to a number of times the determination is executed by the determination unit is set based on the information about the length of the user's finger.

### BRIEF DESCRIPTION OF THE DRAWINGS

In the accompanying drawings:

FIG. 1 is a diagram illustrating an example of the exterior appearance of an information processing device according to a first embodiment and a second embodiment of the present invention;

FIG. 2 is a diagram illustrating an example of the hardware configuration of the information processing device;

FIG. 3 is a diagram illustrating an example of detection point data:

FIG. 4 is a diagram illustrating an example of a screen of a guitar application;

FIG. 5 is a diagram illustrating how to play the guitar application;

FIG. 6 is a functional block diagram of the information processing device;

FIG. 7 is a diagram illustrating an example of processing of a determination unit and a determination control unit;

FIG. 8 is a diagram illustrating an example of processing of a processing executing unit;

FIG. 9 is a flow chart illustrating an example of processing executed by the information processing device;

FIGS. 10A and 10B are diagrams illustrating an example of matrix data;

FIG. 11 is a diagram illustrating processing executed by the information processing device;

FIG. 12 is a diagram illustrating an example of a game screen;

FIG. 13 is a diagram illustrating an example of a game field;

FIG. 14 is a diagram illustrating an example of various ways to touch a finger on a touch panel;

FIG. 15 is a diagram illustrating another example of various ways to touch a finger on a touch panel;

FIG. 16 is a diagram illustrating still another example of various ways to touch a finger on a touch panel;

FIG. 17 is a diagram illustrating yet another example of various ways to touch a finger on a touch panel;

FIG. 18 is a diagram illustrating an example of processing of the determination unit and the determination control unit;

FIG. 19 is a diagram illustrating an example of processing of the processing executing unit;

FIG. 20 is a flow chart illustrating an example of processing executed by the information processing device;

FIG. 21 is a diagram illustrating an example of a game screen of a drive game; and

FIG. 22 is a diagram illustrating an example of an authentication function screen.

### DETAILED DESCRIPTION OF THE INVENTION

Embodiment examples of the present invention are described below in detail with reference to the drawings. An information processing device according to an embodiment of the present invention is implemented by, for example, a cellular phone, a portable information terminal, a personal computer, a portable game machine, an arcade game machine, or a consumer game machine (a stationary game machine). Described here is a case of implementing an information processing device according to an embodiment of the present invention by a cellular phone (or a portable information terminal).

### First Embodiment

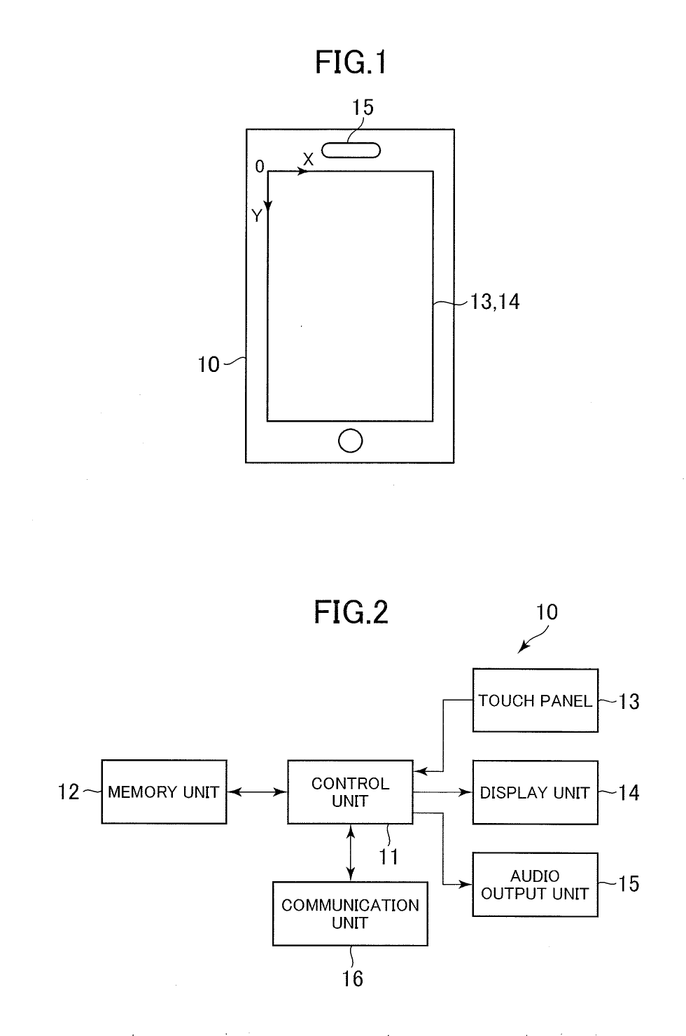

A first embodiment of the present invention is described first. FIG. 1 illustrates an example of the exterior appearance of an information processing device according to the first embodiment of the present invention. FIG. 2 illustrates an example of the hardware configuration of the information processing device according to the first embodiment of the present invention. As illustrated in FIGS. 1 and 2, the information processing device 10 includes a control unit 11, a memory unit 12, a touch panel 13, a display unit 14, an audio output unit 15, and a communication unit 16.

The control unit 11 includes, for example, a microprocessor. The control unit 11 executes processing in accordance with an operating system or other programs that are stored in the memory unit 12. For instance, the control unit 11 executes processing for controlling the components of the information processing device 10. While the control unit 11 does handle processing that is normally performed in a cellular phone (processing of making or receiving a phone call and processing concerning phone communication), the following description on the control unit 11 focuses on processing that is relevant to the present invention. Specifics of the processing executed by the control unit 11 are described later.

The memory unit 12 includes a main memory and a non-volatile memory. The non-volatile memory stores a program executed by the control unit 11. The program is, for example, downloaded from a server machine via a communication network such as the Internet to be stored in the non-volatile memory. Alternatively, the program is copied from a computer-readable information storage medium such as a memory card to be stored in the non-volatile memory. A program read out of the non-volatile memory and data necessary for the control unit 11 to execute processing are written in the main memory.

The touch panel 13 is a common touch panel and detects a point at which a user has touched the touch panel 13. The touch panel 13 is capable of detecting a plurality of points touched by a user. A capacitive touch panel, for example, is employed as the touch panel 13. A capacitive touch panel detects a point at which a user has touched the touch panel based on a change in electric charges that is caused by the user's touch on a surface of the touch panel.

The touch panel 13 supplies information that reflects where the touch panel 13 has been touched by the user. Based on the information supplied from the touch panel 13, the operating system obtains contact points at which the user has touched the touch panel 13. For instance, the operating system obtains a given number of contact points at maximum, and stores these contact points in the memory unit 12. The following description is given on the assumption that five contact points at maximum are obtained and stored in the memory unit 12 by the operating system.

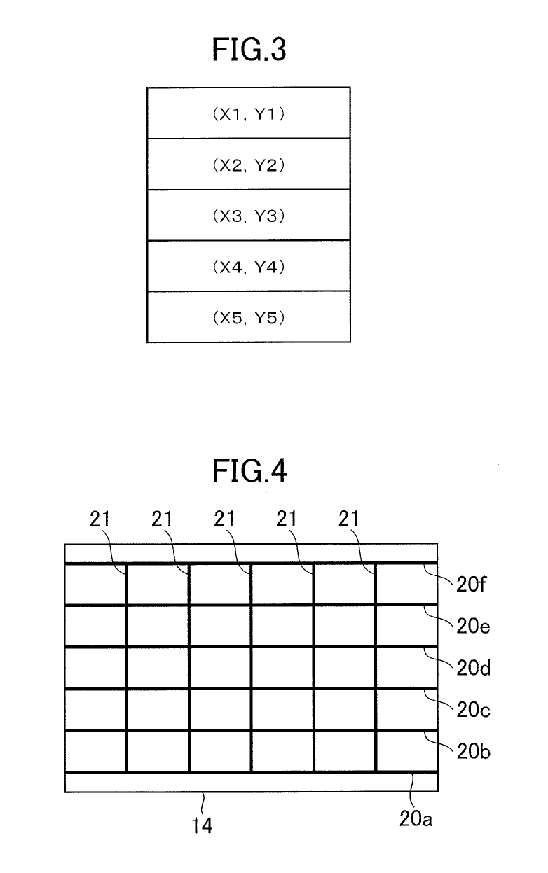

FIG. 3 illustrates an example of detection point data stored in the memory unit 12. The detection point data is data about contact points obtained by the operating system. The detection point data expresses a contact point as, for example, coordinate values of an X-Y coordinate system in which the upper left vertex of the touch panel 13 is the origin O, and the rightward direction and downward direction of the touch panel 13 are the positive X-axis direction and the positive Y-axis direction, respectively, as illustrated in FIG. 1.

When there are three points of contact between the user and the touch panel 13, for example, the three contact points are held in the detection point data. To give another example, when there are five points of contact between the user and the touch panel 13, the five contact points are held in the detection point data. FIG. 3 illustrates the detection point data of the latter case.

In the case where there are six or more points of contact between the user and the touch panel 13, the first to fifth points that the user has touched (in other words, the first to fifth points detected by the touch panel 13) out of these contact points are held in the detection point data. The sixth and subsequent points that the user has touched (in other words, the sixth and subsequent points detected by the touch panel 13) in this case are not held in the detection point data.

The detection point data stores contact points so that the order in which the user has touched (in other words, the order in which the touch panel 13 has detected the contact points) can be identified.

When the contact between the user and the touch panel 13 is broken at one point, this contact point is no longer detected by the touch panel 13 and is deleted from the detection point data. For example, when the detection point data is as illustrated in FIG. 3 and the contact between the user and the touch panel 13 is broken at a point (X1, Y1), the point (X1, Y1) is deleted from the detection point data.

Programs other than the operating system refers to the detection point data stored in the memory unit 12 by the operating system, to thereby figure out points touched by the user.

The touch panel 13 is overlaid on the display unit 14. This enables the user to specify a point on a screen displayed on the display unit 14 by touching the surface of the touch panel 13.

The display unit 14 is, for example, a liquid crystal display panel. The display unit 14 displays a screen in accordance with an instruction from the control unit 11. The audio output unit 15 is, for example, a speaker or headphones. The audio output unit 15 outputs audio (e.g., music or sound effects) in response to an instruction from the control unit 11.

The communication unit 16 is for performing data communication or audio communication. For example, the communication unit 16 executes data communication in response to an instruction from the control unit 11. The communication unit 16 also responds, for example, to a calling instruction from the control unit 11 to call up the other party over a cellular phone network. When receiving an incoming call request over a cellular phone network, the communication unit 16 transfers the request to the control unit 11. The communication unit 16 then executes call receiving processing in response to a call receiving instruction from the control unit 11.

The memory unit 12 of the information processing device 10 stores a guitar application program (or a guitar music simulation game program) which makes the user feel as though they are playing a guitar, and executes the guitar application (or the guitar music simulation game).

FIG. 4 illustrates an example of a screen of the guitar application which is displayed on the display unit 14. The screen of FIG. 4 is the user's view of the display unit 14 of the information processing device 10 rotated clockwise by 90 degrees from the position of the information processing device 10 in FIG. 1. As illustrated in FIG. 4, an image representing a part of a guitar is displayed on the screen. Specifically, the screen displays the guitar's first string 20a, second string 20b, third string 20c, fourth string 20d, fifth string 20e, and sixth string 20f. The screen also displays frets 21 of the guitar. In the following description, the first string 20a to the sixth string 20e may be collectively referred to as “strings 20.”

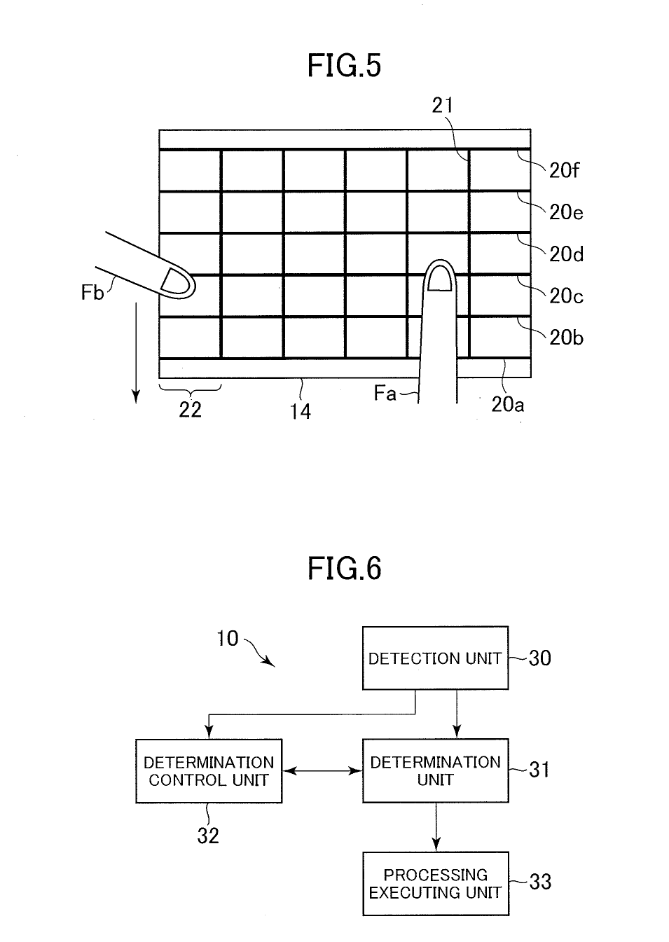

FIG. 5 is a diagram illustrating how to play the guitar application. As when playing an actual guitar, the user touches a finger Fa on the touch panel 13 so as to press down at least one string 20 and makes a slide operation (i.e., an operation of moving a finger while keeping the finger in contact with the touch panel 13) with another finger Fb by plucking the strings 20 in a left end area 22 of the touch panel 13, which causes the audio output unit 15 to output the same sound as that of an actual guitar.

The screen may scroll in accordance with the user's operation (for example, an operation of sliding a finger on the touch panel 13 in the Y-axis direction), with the result that a different part of the guitar is displayed on the screen.

Given below is a description of a technology for appropriately identifying a plurality of points touched by a single finger of a user in the guitar application described above.

FIG. 6 is a functional block diagram illustrating functional blocks that are implemented in the information processing device 10. As illustrated in FIG. 6, the information processing device 10 includes a detection unit 30, a determination unit 31, a determination control unit 32, and a processing executing unit 33. These functional blocks are implemented by, for example, the control unit 11 executing a program that is read out of the memory unit 12.

The detection unit 30 is described first. The detection unit 30 detects a plurality of contact points where the user has touched the touch panel 13. For example, the detection unit 30 is capable of detecting as many contact points as a given upper limit number. In the description given here, the detection unit 30 can detect five contact points at maximum. Contact points detected by the detection unit 30 are stored in the memory unit 12 (see FIG. 3).

The determination unit 31, the determination control unit 32, and the processing executing unit 33 are described next.

The determination unit 31 executes determination about whether or not a target area, which is set based on one of a plurality of contact points detected by the detection unit 30 and which includes the one contact point, includes any other contact point out of the plurality of contact points. When the determination unit 31 determines that at least one other contact point is included in the target area, the determination control unit 32 (setting unit) sets, as a new target area, an area that includes other areas than the formerly set target area and that includes the one contact point and the other contact point. After setting the new target area, the determination control unit 32 instructs the determination unit 31 to execute the determination described above again. The processing executing unit 33 executes processing based on the one contact point and each contact point determined as being included in the target area in the determination which is executed by the determination unit 31 multiple times.

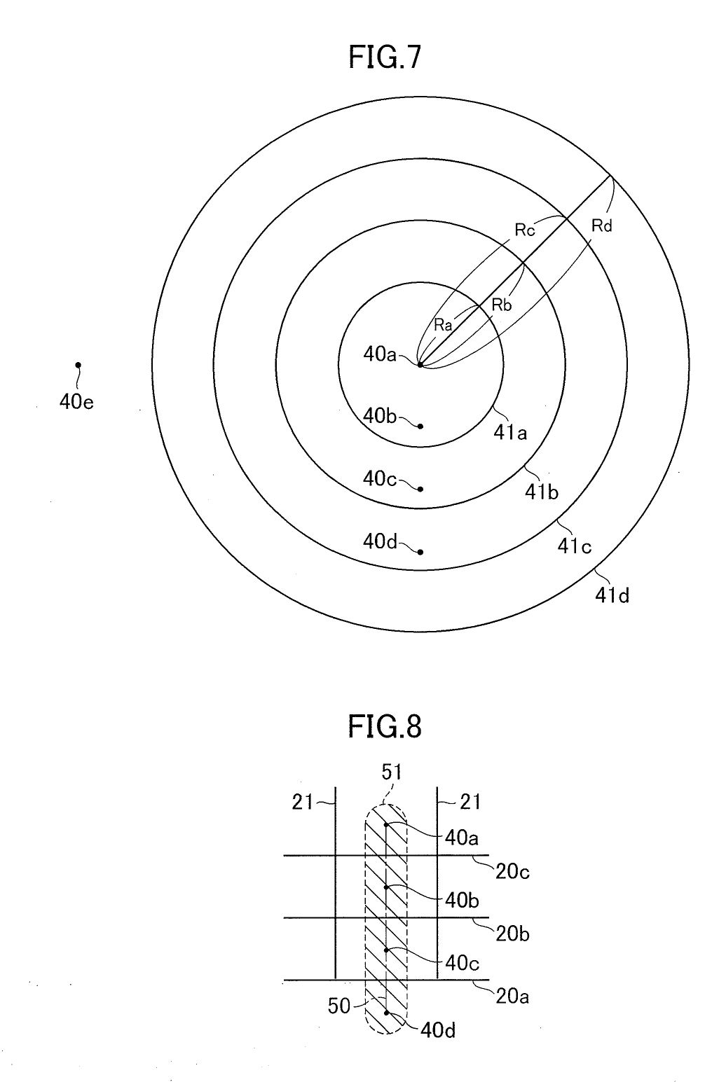

Details of the processing of the determination unit 31 and the determination control unit 32 are described first. FIG. 7 is a diagram illustrating an example of the processing of the determination unit 31 and the determination control unit 32. In FIG. 7, reference symbols 40a, 40b, 40c, 40d, and 40e are used to denote contact points detected by the detection unit 30. The contact points 40a to 40e of FIG. 7 represent an example of contact points that are detected by the detection unit 30 when the user touches the fingers Fa and Fb on the touch panel 13 in the manner illustrated in FIG. 5. In other words, the contact points 40a to 40d are points touched with the finger Fa and the contact point 40e is a point touched with the finger Fb. To simplify the illustration, the distance from the contact point 40e to each of the contact points 40a to 40d in FIG. 7 is shorter than the actual distance.

The premise here is that the user's finger Fa has come into contact with the touch panel 13 gradually from the fingertip toward the proximal end. Specifically, the contact point 40a which is a point of contact between the tip of the finger Fa and the touch panel 13 is detected first, the contact points 40b and 40c are subsequently detected in the order stated, and then the contact point 40d which is a point of contact between the proximal end of the finger Fa and the touch panel 13 is detected. Still later, the finger Fb comes into contact with the touch panel 13 and the contact point 40e which is a point of contact between the finger Fb and the touch panel 13 is detected. In short, the description here assumes that the contact points 40a, 40b, 40c, 40d, and 40e of FIG. 7 correspond respectively to the first contact point (X1, Y1), second contact point (X2, Y2), third contact point (X3, Y3), fourth contact point (X4, Y4), and fifth contact point (X5, Y5) of FIG. 3.

In the example of FIG. 7, the determination unit 31 first determines whether or not a target area 41a, which is a circular area having the first detected contact point 40a at the center and a radius Ra, includes any of the other contact points than the contact point 40a, namely, the contact points 40b to 40e. The radius Ra is determined by taking into account, for example, the resolution and size of the touch panel 13. The same applies to radii Rb, Rc, and Rd, which are described later.

The target area 41a in the example of FIG. 7 includes the contact point 40b, which has been detected next after the detection of the contact point 40a. The determination unit 31 therefore determines that the contact point 40b is included in the target area 41a. The determination control unit 32 (setting unit) in this case sets, as a new target area, a circular area that has a larger radius than the radius Ra of the target area 41a. Specifically, the determination control unit 32 sets as a new target area a target area 41b, which is a circular area having the contact point 40a at the center and the radius Rb (Rb>Ra). The determination control unit 32 then instructs the determination unit 31 to execute the determination again. In the determination executed again, the determination unit 31 determines whether or not the target area 41b includes any of the other contact points than the contact points 40a and 40b, namely, the contact points 40c to 40e.

The target area 41b in the example of FIG. 7 includes the contact point 40c, which has been detected next after the detection of the contact point 40b. The determination unit 31 therefore determines that the contact point 40c is included in the target area 41b. The determination control unit 32 (setting unit) in this case sets, as a new target area, a circular area that has a larger radius than the radius Rb of the target area 41b. Specifically, the determination control unit 32 sets as a new target area a target area 41c, which is a circular area having the contact point 40a at the center and the radius Rc (Rc>Rb). The determination control unit 32 then instructs the determination unit 31 to execute the determination again. In the determination executed again, the determination unit 31 determines whether or not the target area 41c includes any of the other contact points than the contact points 40a to 40c, namely, the contact points 40d and 40e.

The target area 41c in the example of FIG. 7 includes the contact point 40d, which has been detected next after the detection of the contact point 40c. The determination unit 31 therefore determines that the contact point 40d is included in the target area 41c. The determination control unit 32 (setting unit) in this case sets, as a new target area, a circular area that has a larger radius than the radius Rc of the target area 41c. Specifically, the determination control unit 32 sets as a new target area a target area 41d, which is a circular area having the contact point 40a at the center and the radius Rd (Rd>Rc). The determination control unit 32 then instructs the determination unit 31 to execute the determination again. In the determination executed again, the determination unit 31 determines whether or not the target area 41d includes any of the other contact points than the contact points 40a to 40d, namely, the contact point 40e.

The target area 41d in the example of FIG. 7 does not include the contact point 40e, which has been detected next after the detection of the contact point 40d. The determination unit 31 therefore determines that the contact point 40e is not included in the target area 41d.

Details of the processing of the processing executing unit 33 are described next. In the example of FIG. 7, the processing executing unit 33 executes the processing based on the contact point 40a and on the contact points 40b to 40d, which are respectively determined as being included in the target areas 41a to 41c through the determination executed multiple times by the determination unit 31. For instance, the processing executing unit 33 sets a finger area based on the contact point 40a and on the contact points 40b to 40d, and executes guitar sound output control processing based on the finger area.

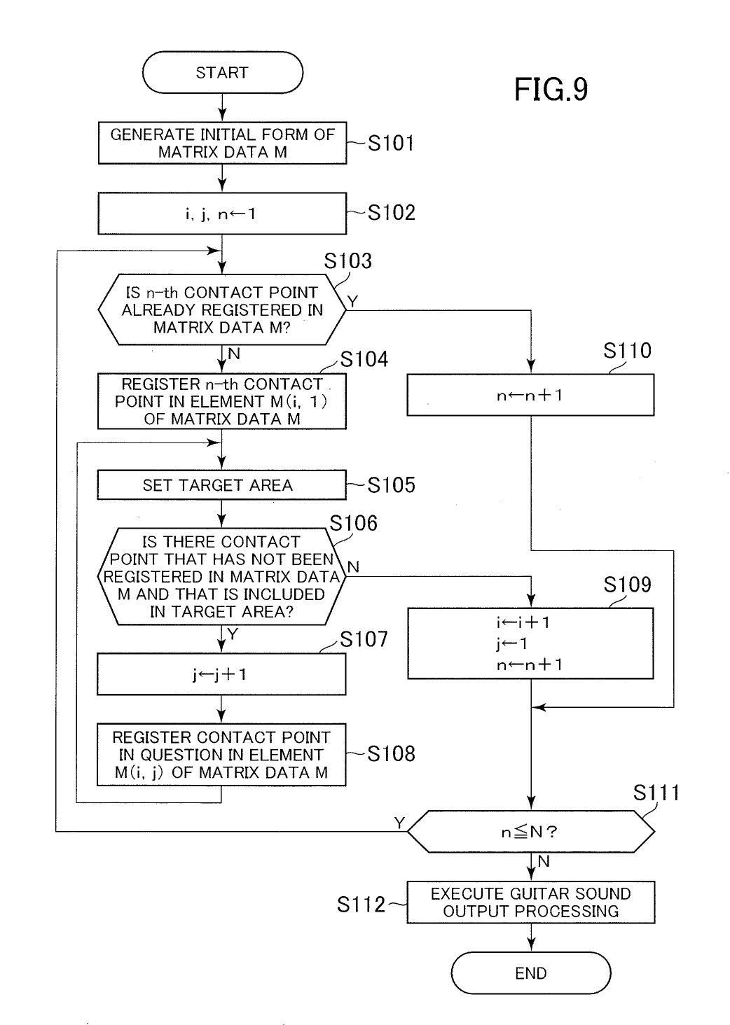

FIG. 8 is a diagram illustrating an example of the processing of the processing executing unit 33. As illustrated in FIG. 8, the processing executing unit 33 sets a finger area 51 based on a line 50, which connects the contact points 40a to 40d. For example, an area that is equal to or less than a given distance from the line 50 is set as the finger area 51. The processing executing unit 33 then determines the finger area 51 as an area touched by a finger of the user, and executes the guitar sound output control processing. Details thereof are described later (see Step S112 of FIG. 9).

A description is given of processing that is executed in the information processing device 10 to implement the determination unit 31, the determination control unit 32, and the processing executing unit 33. FIG. 9 is a flow chart illustrating an example of processing that is executed in the information processing device 10 to output a guitar sound when a slide operation is performed within the left end area 22 of FIG. 5. The control unit 11 executes the processing of FIG. 9 in accordance with the guitar application program which is read out of the memory unit 12, and the control unit 11 thus functions as the determination unit 31, the determination control unit 32, and the processing executing unit 33.

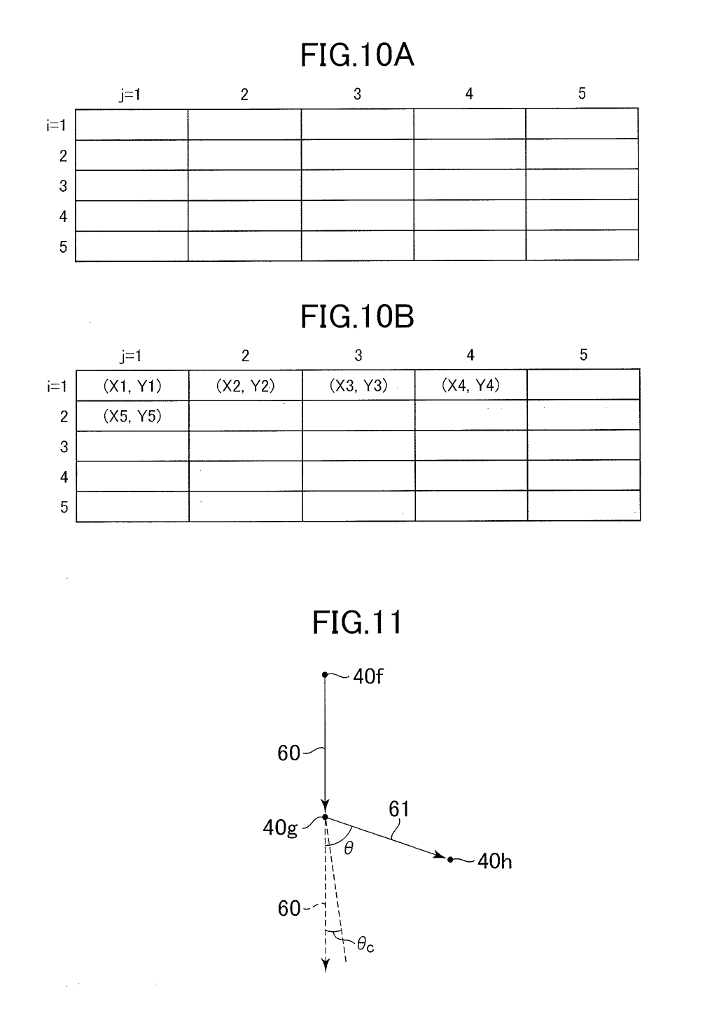

As illustrated in FIG. 9, the control unit 11 first generates an initial form of matrix data M (S101). The matrix data M is data for registering results of determination that is executed through processing described below (Steps S102 to S111). FIG. 10A illustrates an example of the initial form of the matrix data M which is generated in Step S101. The number of rows and the number of columns in the matrix data M are set to, for example, the upper limit for the number of contact points that can be detected in the information processing device 10. In this embodiment, where five contact points are detected at maximum, the matrix data M of FIG. 10A is five rows by five columns matrix data. Immediately after Step S101 is executed, every element is NULL (which means that no information is registered) as illustrated in FIG. 10A.

FIG. 10B is a diagram illustrating an example of the matrix data M after processing described below (Steps S102 to S111) is completed. Executing the following processing registers contact points in elements of the matrix data M as illustrated in FIG. 10B. In the following processing, a plurality of points touched by the same finger are registered in the same row.

The matrix data M of FIG. 10B corresponds to the state of FIG. 7. Accordingly, the contact points 40a, 40b, 40c, and 40d of the finger Fa are registered in the first row of the matrix data M of FIG. 10B, whereas the contact point 40e of the finger Fb is registered in the second row.

After Step S101 is executed, the control unit 11 initializes variables i, j, and n by setting these variables to 1 (S102). As illustrated in FIGS. 10A and 10B, the variable i is used to indicate a row number in the matrix data M and the variable j is used to indicate a column number in the matrix data M. Here, an element in the i-th row and j-th column of the matrix data M is referred to as “M(i, j).” An element in the first row and first column of the matrix data M, for example, is referred to as “M(1, 1).”

After Step S102 is executed, the control unit 11 determines whether or not the n-th contact point stored in the detection point data (a contact point that is in the n-th place in the order of detection) has already been registered in the matrix data M (S103). In the case where the n-th detected contact point has not been registered in the matrix data M, the control unit 11 registers the n-th contact point in an element M (i, 1) of the matrix data M (S104). For example, when the values of the variables i and n are both “1,” the first contact point (X1, Y1) is registered in the element M(1, 1) of the matrix data M.

After Step S104 is executed, the control unit 11 sets a target area (S105). Specifically, the control unit 11 sets as a target area a circular area centered about the contact point that is registered in the element M (i, 1) of the matrix data M. For instance, when the first contact point (X1, Y1) is set in the element M(1, 1) of the matrix data M, a circular area centered about the first contact point (X1, Y1) is set as a target area. The control unit 11 sets, for example, the target area 41a (or one of the target areas 41b to 41d) of FIG. 7.

The radius of the target area in this case is set based on the value of the variable j. The association relation between the variable j and the target area radius is set so that the target area radius is longer when the value of the variable j is larger. For example, the target area radius is set to Ra (see FIG. 7) when the value of the variable j is 1, to Rb (see FIG. 7) when the value of the variable j is 2, to Rc (see FIG. 7) when the value of the variable j is 3, and to Rd (see FIG. 7) when the value of the variable j is 4.

After Step S105 is executed, the control unit 11 determines whether or not any of the detected contact points meet both of the following two conditions (S106):

(1) The contact point has not been registered in the matrix data M.

(2) The contact point is included in the target area.

In the case where the two conditions given above are both met by a plurality of contact points, the control unit 11 finds out which of the plurality of contact points is closest to the contact point registered in the element M(i, j) of the matrix data M, and selects this contact point as the target of processing of Step S108, which is described later.

The interval between two adjacent contact points detected when a single finger touches the touch panel 13 should be a minimum interval corresponding to the resolution of the touch panel 13. Therefore, in cases such as the one described above, a contact point closest to the contact point registered in the element M(i, j) is likely to be touched by the same finger that has touched the contact point registered in the element M (i, j). Therefore, a contact point closest to the contact point registered in the element M(i, j) is selected in cases such as the one described above.

When the value of the variable j is equal to or larger than 2 (in other words, when two or more contact points are already registered in the i-th row), a condition described with reference to FIG. 11 may be added to the above two conditions. In FIG. 11, a contact point 40f represents a contact point registered in the element M(i, j−1) of the matrix data M, and a contact point 40g represents a contact point registered in the element M(i, j) of the matrix data M. A contact point 40h represents a contact point for which the determination about whether or not the conditions are met is made in Step S106.

In the example of FIG. 11, an angle θ between a direction 60, which is from the contact point 40f to the contact point 40g, and a direction 61, which is from the contact point 40g to the contact point 40h, is larger than a reference angle θc. In such cases, the contact point 40h may be regarded as not a point touched by the same finger that has touched the contact points 40f and 40g, and ignored. In other words, a condition given below may be added to the above two conditions in Step S106 so that the control unit 11 determines in Step 106 whether or not any contact point meets all of these three conditions.

(3): The angle θ between the direction 60, which is from a contact point registered in the element M(i, j−1) of the matrix data M to a contact point registered in the element M(i, j), and the direction 61, which is from the contact point registered in the element M(i, j) to the determination target contact point, is equal to or less than the reference angle θc.

When it is determined in Step S106 that there is a contact point that meets the conditions given above, the control unit 11 adds 1 to the value of the variable j (S107) and registers this contact point in the element M(i, j) of the matrix data M (S108). The control unit 11 then executes Step S105 again.

When it is determined in Step S106 that no contact point meets the conditions given above, on the other hand, the control unit 11 adds 1 to the value of the variable i and the value of the variable n each, and initializes the variable j by setting the value of the variable j to 1 (S109). The control unit 11 then determines whether or not the value of the variable n is equal to or less than a constant N (S111). The constant N is an upper limit to the number of contact points that can be detected in the information processing device 10, and is “5” in this embodiment. When the value of the variable n is equal to or less than the constant N, the control unit 11 executes Step S103 again. When the value of the variable n is not equal to or less than the constant N, on the other hand, the control unit 11 executes Step S112, which is described later.

In the case where it is determined in Step S103 that the n-th contact point is already registered in the matrix data M, the control unit 11 adds 1 to the value of the variable n (S110). The control unit 11 then executes Step 111.

Now, a case in which the contact points 40a to 40e of FIG. 7 are stored in the detection point data of FIG. 3 is discussed. In short, the description here assumes that the contact points 40a, 40b, 40c, 40d, and 40e correspond respectively to the first contact point (X1, Y1), second contact point (X2, Y2), third contact point (X3, Y3), fourth contact point (X4, Y4), and fifth contact point (X5, Y5).

In this case, according to the processing of FIG. 9, the contact point 40a which is the first contact point is registered in the element M(1, 1) of the matrix data M first in Step S104 (see FIG. 10B). The target area 41a is set in Step S105. The contact point 40b, which is the second contact point and included in the target area 41a, is registered in the element M(1, 2) of the matrix data M (see FIG. 10B) as a result of executing Steps S107 and S108.

Thereafter, Step S105 is executed again and the target area 41b is set as a result. Executing Steps S107 and S108 registers the contact point 40c, which is the third contact point and included in the target area 41b, in the element M(1, 3) of the matrix data M (see FIG. 10B). Step S105 is executed once again and the target area 41c is set as a result. Executing Steps S107 and S108 registers the contact point 40d, which is the fourth contact point and included in the target area 41c, in the element M(1, 4) of the matrix data M (see FIG. 10B).

Subsequently, Step S105 is executed once more and the target area 41d is set as a result. The fifth contact point, namely, the contact point 40e, however, is not included in the target area 41d and therefore is not registered in the first row of the matrix data M. The contact point 40e is registered in the element M(2, 1) of the second row which is a row next to the first row, as a result of executing Steps S109, S111, S103, and S104 (see FIG. 10B).

When it is determined in Step S111 that the variable n exceeds the constant N, the control unit 11 executes the guitar sound output processing (S112).

For example, the control unit 11 obtains contact points registered in the respective rows of the matrix data Mon a row-by-row basis. In the case where only one contact point is registered in a single row, the control unit 11 sets, as the finger area 51, an area that is equal to or less than a given distance from the registered contact point. In the case where a plurality of contact points are registered in a single row, on the other hand, the control unit 11 sets the finger area 51 based on, for example, the line 50 which connects the plurality of contact points as illustrated in FIG. 8.

Based on the finger area 51 which is set in the manner described above, the control unit 11 determines how the first string 20a to sixth string 20f of the guitar are pressed down. Specifically, the control unit 11 determines which of the strings 20 is pressed down and which point along the string 20 is pressed down. The control unit 11 then instructs the audio output unit 15 to output a guitar sound based on the results of the determination. The memory unit 12 stores in advance information about how the first string 20a to the sixth string 20f are pressed down and guitar sound data for outputting a guitar sound in association with each other. The controls unit 11 refers to what is stored in the memory unit 12 to read guitar sound data that is associated with results of the determination described above, and instructs the audio output unit 15 to output a guitar sound based on the read guitar sound data. This processing is thus completed.

According to the information processing device 10 of the first embodiment described above, a plurality of points touched by a single finger are identified appropriately.

### Second Embodiment

A second embodiment of the present invention is described next. An information processing device according to the second embodiment has the same exterior appearance and hardware configuration as those in the first embodiment (FIGS. 1 and 2).

The information processing device 10 (a game machine) according to the second embodiment runs a game based on a game program that is stored in the memory unit 12. For example, the information processing device 10 runs a game in which the aim is to lead voluntarily moving game characters to a goal (an objective point).

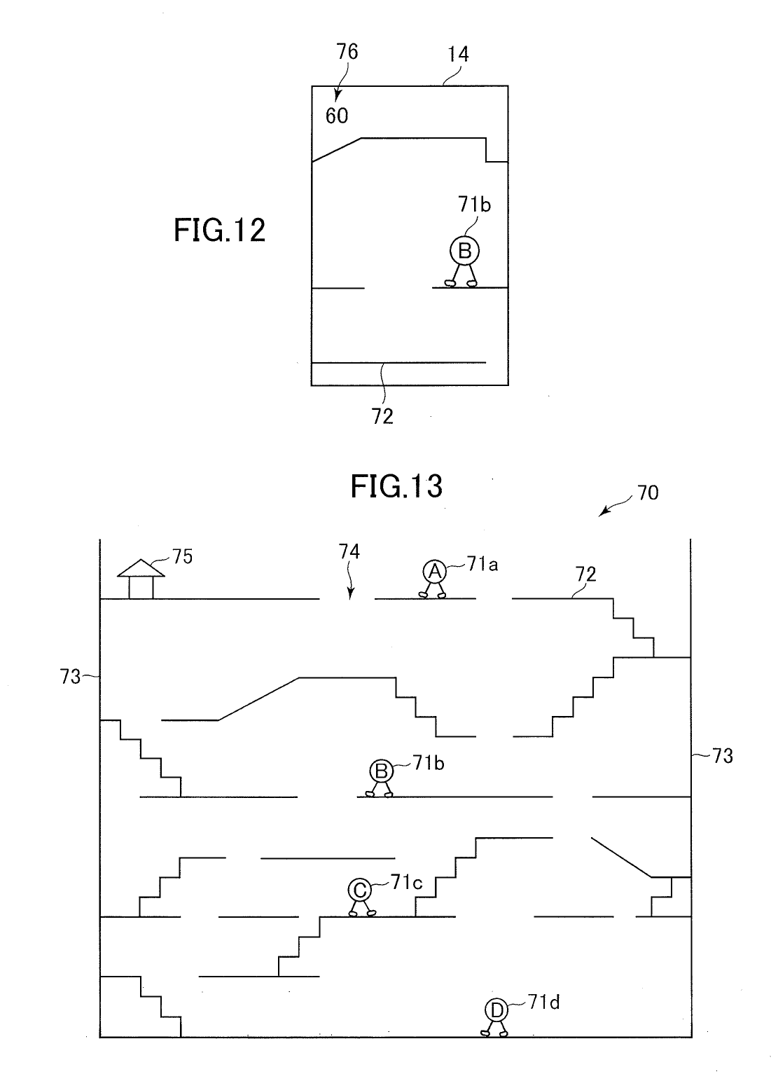

FIG. 12 illustrates an example of a game screen displayed on the display unit 14. The game screen displays a part of a game field. The user can scroll the game screen by moving a finger that is touching the touch panel 13. The game screen may instead display the entirety of the game field.

FIG. 13 illustrates an example of the game field. As illustrated in FIG. 13, four game characters 71a, 71b, 71c, and 71d are arranged in the game field 70. An alphabet letter “A” is attached to the game character 71a. An alphabet letter “B” is attached to the game character 71b. An alphabet letter “C” is attached to the game character 71c. An alphabet letter “D” is attached to the game character 71d. In the following description, the game characters 71a, 71b, 71c, and 71d may collectively be referred to as “game characters 71.”

The game characters 71 move voluntarily on floors 72. The floors 72 are basically flat but are sloped or stepped in places as illustrated in FIG. 13. When bumping into walls 73, the game characters 71 turn to start traveling in a direction opposite to the previous traveling direction.

As illustrated in FIG. 13, holes 74 are provided in the floors 72. When coming upon the holes 74, the game characters 71 fall to the lower level as a rule. Specifically, the game character 71 that comes upon one of the holes 74 falls to the floor 72 that is positioned below the hole 74, and starts moving on this floor 72.

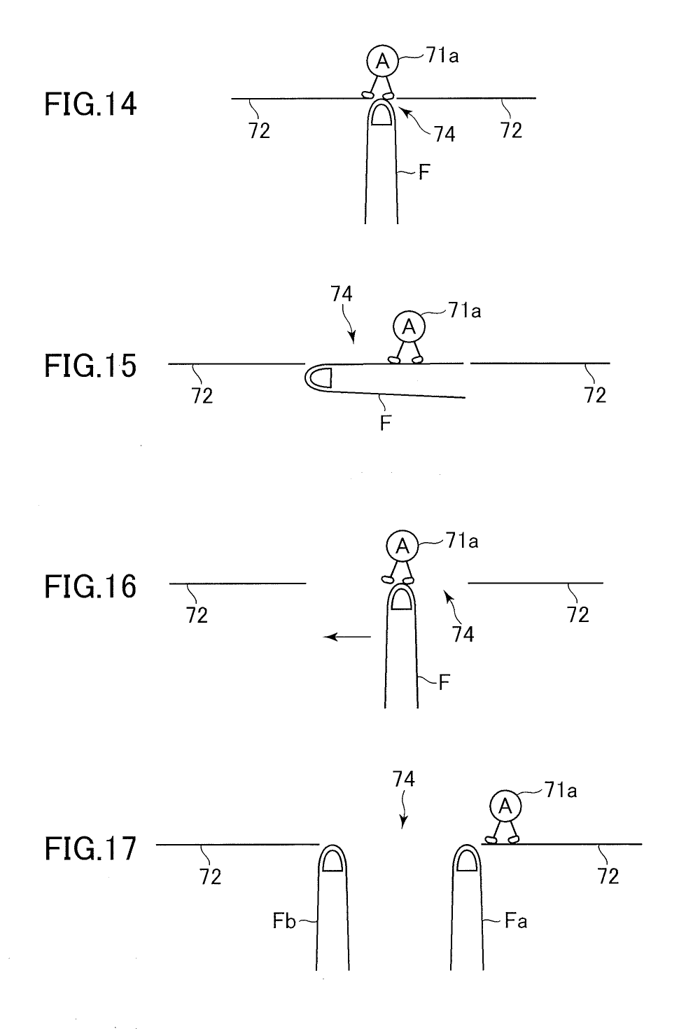

The user can prevent the game character 71 from falling into the hole 74 by touching a finger on the touch panel 13 so as to cover the hole 74. For example, when the user puts a finger F on the touch panel 13 to cover the hole 74 in a manner illustrated in FIG. 14, the finger F of the user serves as abridge that stretches from one end of the hole 74 to the other end. As a result, the game character 71 can keep traveling instead of falling into the hole 74.

In the case where the hole 74 is relatively large, the user can prevent the game character 71 from falling into the hole 74 by, for example, touching the finger F on the touch panel 13 in a manner that covers the hole 74 with the entire finger F as illustrated in FIG. 15.

The user can also prevent the game character 71 from falling into the hole 74 by, for example, moving the finger F that is kept in contact with the touch panel 13 in pace with the traveling of the game character 71 as illustrated in FIG. 16.

In this game, the user aims to lead the game characters 71 to a home 75 (the goal) by covering the holes 74 with a finger or fingers. The game character 71 that has reached the home 75 enters the home 75.

However, the game is designed such that the game characters 71 can enter the home 75 only in a predetermined order. Specifically, the game characters 71a to 71d are allowed to enter the home 75 only in the following order: 71a, 71b, 71c, 71d. Therefore, in the case where, for example, the game character 71b reaches the home 75 when the game character 71a has not reached the home 75 yet (in other words, when the game character 71a has not entered the home 75), the game character 71b does not enter the home 75. The game character 71b in this case moves past the home 75 and keeps traveling. The user accordingly needs to lead the game characters 71a to 71d so that the game characters 71a, 71b, 71c, and 71d reach the home 75 in this order.

A time limit is also set in this game. The user is therefore required to lead the game characters 71a to 71d into the home 75 within the time limit. A remaining time 76 is displayed on the game screen as illustrated in FIG. 12. The user aims to bring the game characters 71a to 71d into the home 75 before the remaining time 76 reaches zero.

To implement the game described above, the information processing device 10 needs to figure out how the touch panel 13 is touched with the user's finger(s).

In an example illustrated in FIG. 17, the user touches the finger Fa at one end of one of the holes 74 and another finger Fb at the other end of the hole 74. The user's fingers Fa and Fb in this case are not serving as a bridge that stretches from one end of the hole 74 to the other end of the hole 74. The information processing device 10 therefore needs to make the game character 71 that comes upon this hole 74 fall into the hole 74.

In order to make the game character 71 fall into the hole 74 in the case described above, processing of controlling the movement of the game characters 71 needs to be varied depending on whether the touch panel 13 is touched with the finger F in the manner illustrated in FIG. 15 or with the fingers Fa and Fb in the manner illustrated in FIG. 17. A configuration for accomplishing this varying is described below.

Functional blocks implemented in the information processing device 10 of the second embodiment are the same as those in the first embodiment (see FIG. 6). In other words, the information processing device 10 of the second embodiment, too, includes the detection unit 30, the determination unit 31, the determination control unit 32, and the processing executing unit 33. Processing of the detection unit 30 in the second embodiment is the same as that in the first embodiment, and a description of the processing is therefore omitted here.

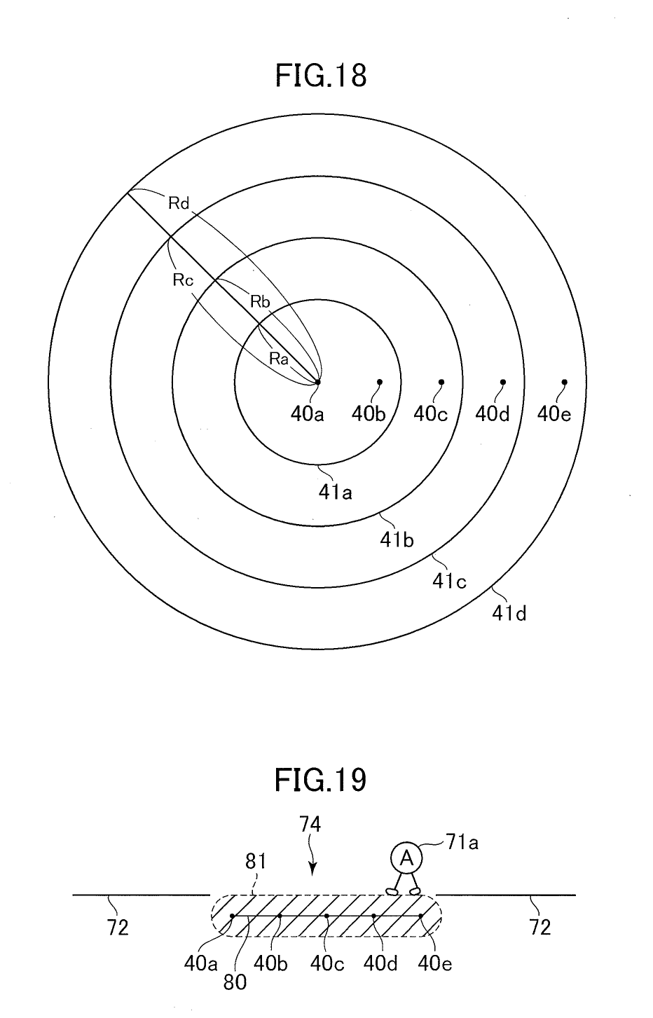

Processing of the determination unit 31 and the determination control unit 32 in the second embodiment is also the same as that in the first embodiment. FIG. 18 is a diagram illustrating an example of the processing of the determination unit 31 and the determination control unit 32 in the second embodiment. In FIG. 18, reference symbols 40a, 40b, 40c, 40d, and 40e are used to denote an example of contact points that are detected by the detection unit 30 when the user touches the touch panel 13 with one finger F in the manner illustrated in FIG. 15.

The premise here is that the user's finger F has come into contact with the touch panel 13 gradually from the fingertip toward the proximal end. Specifically, the contact point 40a which is a point of contact between the tip of the finger F and the touch panel 13 is detected first, the contact points 40b, 40c, and 40d are subsequently detected in the order stated, and finally the contact point 40e which is a point of contact between the proximal end of the finger F and the touch panel 13 is detected.

In the example of FIG. 18, the determination unit 31 first determines whether or not a target area 41a, which is a circular area having the first detected contact point 40a at the center and a radius Ra, includes any of the other contact points than the contact point 40a, namely, the contact points 40b to 40e. Similarly to the first embodiment, the radius Ra is determined by taking into account, for example, the resolution and size of the touch panel 13. The same applies to radii Rb, Rc, and Rd, which are described later.

The target area 41a in the example of FIG. 18 includes the contact point 40b, which has been detected next after the detection of the contact point 40a. The determination control unit 32 in this case sets as a new target area a target area 41b, which is a circular area having the contact point 40a at the center and a radius Rb (Rb>Ra), and instructs the determination unit 31 to execute the determination again. In the determination executed again, the determination unit 31 determines whether or not the target area 41b includes any of the other contact points than the contact points 40a and 40b, namely, the contact points 40c to 40e.

The target area 41b in the example of FIG. 18 includes the contact point 40c, which has been detected next after the detection of the contact point 40b. The determination control unit 32 in this case sets as a new target area a target area 41c, which is a circular area having the contact point 40a at the center and a radius Rc (Rc>Rb), and instructs the determination unit 31 to execute the determination again. In the determination executed again, the determination unit 31 determines whether or not the target area 41c includes any of the other contact points than the contact points 40a to 40c, namely, the contact points 40d and 40e.

The target area 41c in the example of FIG. 18 includes the contact point 40d, which has been detected next after the detection of the contact point 40c. The determination control unit 32 in this case sets as a new target area a target area 41d, which is a circular area having the contact point 40a at the center and a radius Rd (Rd>Rc), and instructs the determination unit 31 to execute the determination again. In the determination executed again, the determination unit 31 determines whether or not the target area 41d includes any of the other contact points than the contact points 40a to 40d, namely, the contact point 40e.

The target area 41d in the example of FIG. 18 includes the contact point 40e, which has been detected next after the detection of the contact point 40d. The determination unit 31 therefore determines that the contact point 40e is included in the target area 41d.

Processing of the processing executing unit 33 in the second embodiment, too, is basically the same as that in the first embodiment. Specifically, the processing executing unit 33 in the second embodiment is similar to that of the first embodiment in that, in the example of FIG. 18, the processing is executed based on the contact point 40a and on the contact points 40b to 40e, which are respectively determined as being included in the target areas 41a to 41d in the determination executed multiple times by the determination unit 31.

However, concrete processing of the processing executing unit 33 in the second embodiment differs from the one in the first embodiment because the game program described above is executed in the second embodiment. For example, the processing executing unit 33 in the second embodiment sets a hit area based on the contact point 40a and on the contact points 40b to 40e, and executes processing of controlling the game characters 71 based on the hit area.

FIG. 19 is a diagram illustrating an example of the processing of the processing executing unit 33 in the second embodiment. As illustrated in FIG. 19, the processing executing unit 33 sets a hit area 81 (bridge) based on a line 80, which connects the contact points 40a to 40e. For example, an area that is equal to or less than a given distance from the line 80 is set as the hit area 81. When one of the game characters 71 reaches the hit area 81, the processing executing unit 33 controls the movement of the game character 71 so that the game character 71 travels on the hit area 81.

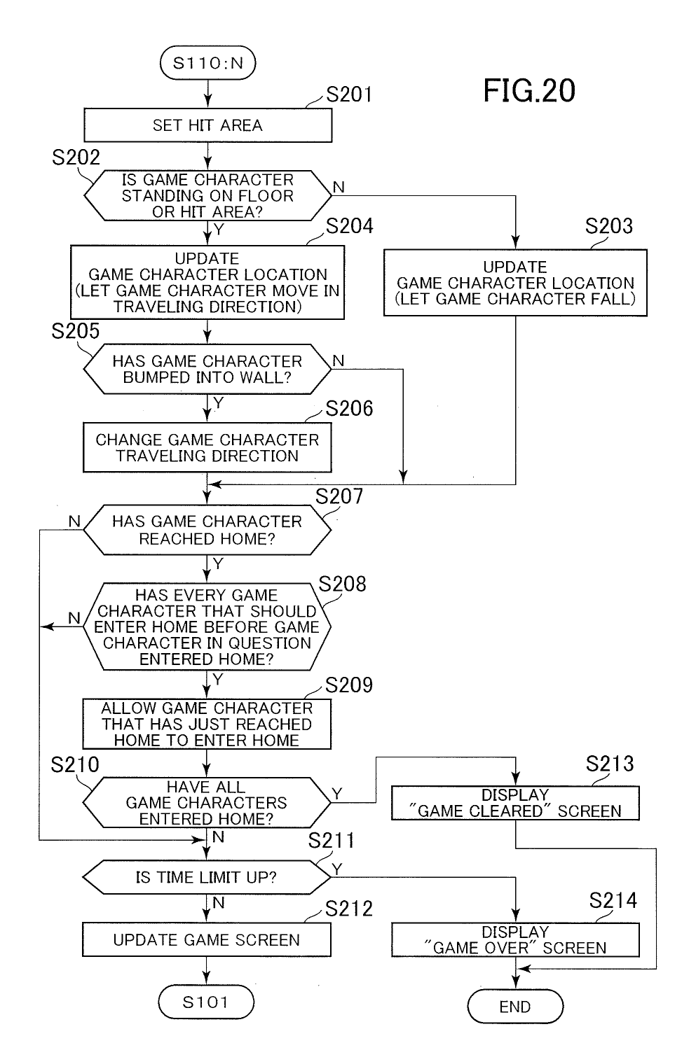

Of processing executed in the information processing device 10 of the second embodiment between the start and end of the game, an example of processing relevant to the present invention is described next. The processing executed in the information processing device 10 of the second embodiment between the start and end of the game is similar to the processing of FIG. 9. A difference is that processing illustrated in FIG. 20 is executed in the second embodiment in place of Step S112 of FIG. 9.

The processing of FIG. 20 is executed based on data stored in the memory unit 12. This data is described before a description is given of the processing of FIG. 20.

The memory unit 12 stores, for example, data for displaying the game screen. Specifically, the memory unit 12 stores image data of the game field 70 and image data of the game characters 71.

The memory unit 12 also stores, for example, data indicating the current status of the game (hereinafter, referred to as “game status data”). Information held in the game status data is, for example, as follows:
Information indicating the state of the game characters 71a to 71d (e.g., the location and the traveling direction)
Information indicating the progress of time toward the time limit (information indicating the remaining time)
Information indicating which area in the game field 70 is to be displayed on the game screen

The information indicating the state of the game characters 71a to 71d includes information indicating whether or not the game characters 71a to 71d have entered the home 75.

The processing of FIG. 20 is now described. As illustrated in FIG. 20, the control unit 11 first sets the hit area based on the contents of the matrix data M (S201). For example, the control unit 11 obtains contact points registered in the respective rows of the matrix data Mon a row-by-row basis. In the case where only one contact point is registered in a single row, the control unit 11 sets the hit area based on this contact point. For example, the control unit 11 sets as the hit area 81 a circular area that has the registered contact point at the center and a radius of a given distance. In the case where a plurality of contact points are registered in a single row, on the other hand, the control unit 11 sets the hit area 81 based on, for example, a line 80 which connects the plurality of contact points as illustrated in FIG. 19.

After Step S201 is executed, the control unit 11 executes processing for updating the state information of the game characters 71 (S202 to S209 of FIG. 20). This processing is executed for each of the game characters 71a to 71d separately.

The control unit 11 first determines whether or not the game character 71 that is being processed is standing on one of the floors 72 or on the hit area 81 (S202). In the case where it is determined that the game character 71 is not standing on one of the floors 72 or on the hit area 81, the control unit 11 updates the location of the game character 71 so that the game character 71 falls to the lower level (S203). The location of the game character 71 in this case is updated with a point that is a given distance below the current point. After Step S203 is executed, the control unit 11 executes Step S207, which is described later.

In the case where it is determined that the game character 71 is standing on one of the floors 72 or on the hit area 81, on the other hand, the control unit 11 updates the location of the game character 71 so that the game character 71 moves in the traveling direction (S204). The location of the game character 71 in this case is updated with a point that is a given distance away from the current point in the traveling direction.

After Step S204 is executed, the control unit 11 determines whether or not the game character 71 has bumped into one of the walls 73 (S205). When it is determined that the game character 71 has bumped into one of the walls 73, the control unit 11 changes the traveling direction of the game character 71 to the direction opposite to the previous traveling direction (S206).

In the case where Step S206 is executed, or in the case where it is determined in Step S205 that the game character 71 has bumped into neither of the walls 73, the control unit 11 determines whether or not the game character 71 has reached the home 75 (S207). When it is determined that the game character 71 has reached the home 75, the control unit 11 determines whether or not every game character 71 that should enter the home 75 before the game character 71 in question has entered the home 75 (S208). For example, in the case where the game character 71 that has just reached the home 75 is the game character 71c, the control unit 11 determines whether or not the game characters 71a and 71b, which should enter the home 75 before the game character 71c, are both already in the home 75.

In the case where every game character 71 that should enter the home 75 before the game character 71 that has just reached the home 75 has entered the home 75, the control unit 11 allows the game character 71 that has just reached the home 75 to enter the home 75 (S209). The control unit 11 then determines whether or not all of the game characters 71 have entered the home 75 (S210). Specifically, the control unit 11 determines whether or not the game characters 71a to 71d are all in the home 75. In the case where it is determined that all of the game characters 71 have entered the home 75, the control unit 11 displays a “game cleared” screen on the display unit 14 (S213). This processing is then finished and the game is ended.

In the case where it is determined in Step S207 that the game character 71 has not reached the home 75, in the case where it is determined in Step S208 that not every game character 71 that should enter the home 75 before the game character 71 that has just reached the home 75 has entered the home 75, or in the case where it is determined in Step S210 that not all of the game characters 71 have entered the home 75, the control unit 11 determines whether or not the time limit is up (whether or not the remaining time is zero) (S211). When it is determined that the time limit is up (when it is determined that the remaining time is zero), the control unit 11 displays a “game over” screen on the display unit 14 (S214). This processing is then finished and the game is ended.

When it is determined that the time limit is not up (when it is determined that the remaining time is not zero), on the other hand, the control unit 11 updates the game screen (S212). For example, the control unit 11 generates a game screen in a VRAM. based on the state information (e.g., the location and the traveling direction) of the game characters 71a to 71d that has been updated in Steps S202 to S209. The game screen generated in the VRAM is displayed on the display unit 14.

When generating the game screen, the control unit 11 determines whether or not the user has made a game screen scrolling operation. In other words, the control unit 11 determines whether or not the user has moved a finger touching the touch panel 13. In the case where the user has moved a finger touching the touch panel 13, the control unit 11 changes the display target area (the area to be displayed on the game screen) of the game field 70 based on a direction in which the finger has been moved. Through execution of this processing, the game screen scrolls in a direction corresponding to the moving direction of the user's finger.

After Step S212 is executed, the control unit 11 executes Step S101 of FIG. 9. Steps S101 to S111 and Steps S201 to S212 are executed repeatedly until the game is cleared (i.e., the control unit 11 determines in Step S210 that all of the game characters 71 have entered the home 75) or until the game is over (the control unit 11 determines in Step S211 that the time limit is up). The repeated execution of Steps S101 to S111 and Steps S201 to S212 takes place at given intervals (e.g., 1/60^{th} of a second intervals).

According to the information processing device 10 of the second embodiment described above, a plurality of points touched by a single finger can be identified appropriately. As a result, game processing that is executed can be varied between, for example, the case where a plurality of points are touched with a single finger (see FIG. 15, for example) and the case where a plurality of points are touched with a plurality of fingers (see FIG. 17, for example).

The present invention is not limited to the first embodiment and second embodiment described above.

(A) For example, in Step S106 of FIG. 9, the control unit 11 may determine whether or not a contact point that is in the (n+j)-th place in the order of detection meets both of the two conditions given above (or all of the three conditions given above). In the case where the (n+j)-th detected contact point meets both of the two conditions given above (or all of the three conditions given above), the control unit 11 may register this contact point in the element M(i, j) of the matrix data M in Step S108. In the case where it is determined that the (n+j)-th detected contact point does not meet both of the two conditions given above (or all of the three conditions given above), on the other hand, the control unit 11 may execute Step S109.

When touching a plurality of points with a single finger, it is common for users to first touch the tip of the finger to the touch panel 13 and subsequently bring other portions of the finger into contact with the touch panel 13. The portions of the finger in this case come into contact with the touch panel 13 in an order starting from the fingertip and proceeding toward the proximal end of the finger. With Modification Example (A) described above, points touched with a single finger can be identified by taking into consideration the common way the user touches a plurality of points with a single finger. As a result, points touched with a single finger can be identified more definitively.

(B) For example, in Steps S104 and S108 of FIG. 9, the contact point registered in the matrix data M may be deleted from the detection point data (see FIG. 3).

When the contact point (X1, Y1), for example, is registered in the matrix data M, the operating system may be instructed to delete the contact point (X1, Y1) from the detection point data. Following this instruction, the operating system may delete the contact point (X1, Y1) from the detection point data.

As described above, in the case where five contact points are already stored in the detection point data, if a new contact point comes into existence, no new contact point is obtained by the operating system. In this regard, if the contact point is deleted from the detection point data, the operating system obtains the new contact point. The new contact point is stored in the detection point data in place of the deleted contact point.

When the contact point is deleted from the detection point data as described above, a new contact point is obtained by the operating system and can be used in processing (e.g., the processing of setting the finger area 51 or the hit area 81). If the information processing device 10 is designed to, for example, keep the matrix data M for at least a given period of time, the contact point deleted from the detection point data is kept in the matrix data M and can be used in processing (e.g., the processing of generating new matrix data M and the processing of setting the finger area 51 or the hit area 81) as well. Therefore, with Modification Example (B), more contact points than an upper limit set for the number of contact points that can be obtained by the operating system can be used in processing (e.g., the processing of setting the finger area 51 or the hit area 81).

(C) For example, the processing of FIG. 9 may be executed by taking into consideration the length of the user's finger.

(C-1) For example, in Step S105 of FIG. 9, the size of the target area may be controlled based on information about the length of the user's finger. Specifically, the target area may be set so that the size of the target area is larger when the user's finger is longer.

In this modification example, the information about the length of the user's finger is stored in the memory unit 12. The information about the length of the user's finger may be input by the user in advance. Alternatively, the information about the length of the user's finger may be obtained automatically based on results of detecting contact points when the user touches a finger on the touch panel 13 from the proximal end of the finger to the tip of the finger.

The memory unit 12 in this modification example also stores association relation information that indicates an association relation between the information about the length of the user's finger and information about the target area size. The information about the target area size is, for example, information about the radius of the target area. The association relation information is set so that the size of the target area is larger (the radius of the target area is longer) when the user's finger is longer. In Step S105 of FIG. 9, the size of the target area (the length of the radius of the target area) is set based on the information about the length of the user's finger and on the association relation information.

With Modification Example (C-1), a plurality of points touched with a single finger can be identified by taking into consideration the length of the user's finger.

(C-2) For example, in the processing of FIG. 9, the repeated execution of Steps S105 to S108 is ended to execute Step S109 when it is determined in Step S106 that no contact point meets both of the two conditions given above (or all of the three conditions given above). However, in the processing of FIG. 9, the repeated execution of Steps S105 to S108 may be ended to execute Step S109 also when the value of the variable j reaches a reference value.

The reference value may be controlled based on the information about the length of the user's finger. In other words, the upper limit to the number of times the execution of Steps S105 to S108 is repeated may be controlled based on the information about the length of the user's finger.

In this modification example, too, the information about the length of the user's finger is stored in the memory unit 12. The memory unit 12 in this modification example also stores association relation information that indicates an association relation between the information about the length of the user's finger and information about the reference value (the upper limit repetition count). This association relation information is set so that the reference value is larger (the upper limit repetition count is higher) when the length of the user's finger is longer. In the processing of FIG. 9, the reference value (the upper limit repetition count) is set based on the information about the length of the user's finger and on the association relation information, and when the value of the variable j reaches the reference value, the repeated execution of Steps S105 to S108 is ended to execute Step S109.

In this way, too, a plurality of points touched with a single finger can be identified by taking into consideration the length of the user's finger.

(D) For example, in the second embodiment, Steps S101 to S111 of FIG. 9, namely, pre-processing for setting the hit area 81, may be executed only when at least one of the game characters 71 is located above one of the holes 74. This way, the processing load is lessened.

(E) For example, in the second embodiment, the user's finger may play the same role as that of the walls 73 when the user puts a finger on the touch panel 13 so as to hinder the traveling of one of the game characters 71. When the game character 71 reaches a point touched by the user's finger in this case, the game character 71 may turn to start traveling in a direction opposite to the previous traveling direction, as when bumping into the walls 73.

(F) For example, in the first embodiment, other programs than a guitar application program may be executed. In short, the present invention is also applicable to other applications than a guitar application. In the second embodiment, too, other games than the one described above may be run. In short, the present invention is also applicable to other games than the one described above. The present invention can be applied to an application or a game that needs to identify a plurality of points touched with a single finger. The present invention can be applied to an information processing device that needs to identify a plurality of points touched with a single finger.

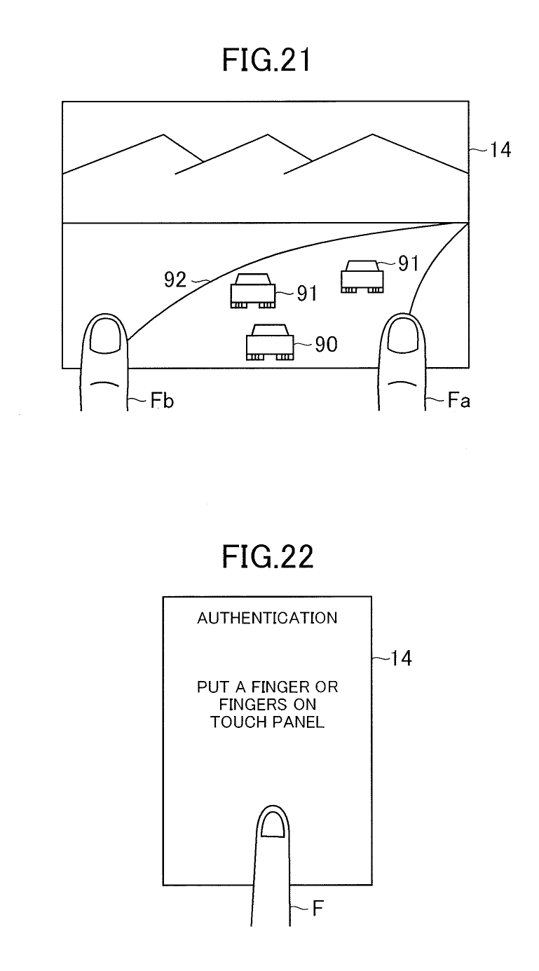

(F-1) For example, the present invention is also applicable to a drive game in which a user enjoys driving an automobile or a motorcycle. FIG. 21 illustrates an example of a game screen of the drive game. The game screen of FIG. 21 displays automobiles 90 and 91 driving on a road 92. The automobile 90 is a car driven by the user and the automobiles 91 are competitor cars.

In this drive game, the user holds both ends of the information processing device 10 (a cellular phone) in both hands and touches the finger Fa (for example, thumb) of their right hand and the finger Fb (for example, thumb) of their left hand on the touch panel 13. The finger Fa corresponds to, for example, an accelerator pedal, and the value of a parameter indicating how much the accelerator pedal is depressed is set based on the length of the portion of the finger Fa that is touching the touch panel 13. In the case where only the tip of the finger Fa is in contact with the touch panel 13, for example, the length of the portion of the finger Fa that is touching the touch panel 13 is relatively short and the degree of depression of the accelerator pedal is set accordingly small. To give another example, in the case where a portion of the finger Fa from the fingertip to the first joint is in contact with the touch panel 13, the length of the portion of the finger Fa that is touching the touch panel 13 is relatively long and the degree of depression of the accelerator pedal is set accordingly large. The finger Fb, on the other hand, corresponds to a clutch pedal, and the value of a parameter indicating how much the clutch pedal is depressed is set based on the length of the portion of the finger Fb that is touching the touch panel 13. The relation between the length of the portion of the finger Fb that is touching the touch panel 13 and the degree of depression of the clutch pedal is the same as the relation between the finger Fa and the accelerator pedal.

In the drive game described above, the length of the portion of the finger Fa or Fb that is touching the touch panel 13 is obtained based on the matrix data M that is obtained in Steps S101 to S111 of FIG. 9. For example, the length of the line 80 which connects a plurality of contact points registered in a single row of the matrix data M. is obtained as the length of the portion of the finger that is touching the touch panel 13.

According to the drive game described above, the user can adjust the degree of depression of the accelerator pedal or the clutch pedal by adjusting the length of the portion of the finger Fa or Fb that is touching the touch panel 13. In other words, applying the present invention to the drive game can make accelerator pedal operation and clutch pedal operation more lifelike.

(F-2) For example, the present invention is also applicable to an authentication function in a security system and the like. Every user touches the touch panel 13 in a manner unique to the user. The number of fingers used to touch the touch panel 13, where on the touch panel 13 is touched with a finger, and the length of the portion of a finger that is touching the touch panel 13, for example, must vary from one user to another. Therefore, the authentication function described above executes authentication processing based on the way the user touches the touch panel 13.

FIG. 22 illustrates an example of a screen of the authentication function described above. As illustrated in FIG. 22, the authentication function screen prompts the user to put a finger or fingers on the touch panel 13. In this case, the user puts an arbitrary number of fingers on arbitrary points on the touch panel 13. In the example of FIG. 22, the user puts a single finger F on the touch panel 13.

The authentication function then obtains the number of fingers touching the touch panel 13, where on the touch panel 13 is touched with a finger, and the length of the portion of a finger touching the touch panel 13. In the example of FIG. 22 where the user touches the touch panel 13 with the single finger F, “one finger” is obtained as the number of fingers touching the touch panel 13, and a point touched with the finger F and the length of the portion of the finger F touching the touch panel 13 are obtained as well.

The memory unit 12 stores, as user authentication information, a combination of a reference finger number, a reference contact point, and a reference finger length, and these pieces of reference information are compared with the obtained information described above. In the example of FIG. 22, the number of fingers touching the touch panel 13 (one finger) is compared against the reference finger number. The contact point of the finger F is compared against the reference contact point. The length of the portion of the finger F touching the touch panel 13 is compared against the reference finger length. Whether or not the user is authenticated successfully is determined based on results of those comparisons. For example, whether or not the similarity is high is determined by determining whether or not the similarity is equal to or higher than a reference value. The authentication is determined as a success when the similarity is high, and as a failure when the similarity is low.

With Modification Example (F-2), an authentication function that performs authentication based on the way the user touches the touch panel 13 is implemented.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An information processing device, comprising:
a touch panel;
detection unit configured to detect a plurality of contact points where a user has touched the touch panel;
determination unit configured to execute determination on whether or not a target area, which is set based on one of the plurality of contact points and which includes the one of the plurality of contact points, includes any other contact point out of the plurality of contact points;
setting unit configured to set, in the case where the determination unit determines that the target area includes the any other contact point, an area that includes an area other than an area formerly set as the target area and that includes the one of the plurality of contact points and the any other contact point, as a new target area based on the one of the plurality of contact points; and
processing executing unit configured to execute, in the case where the determination unit executes the determination multiple times, processing based on the one of the plurality of contact points and on each contact point determined as being included in the target area in the determination executed multiple times.

2. The information processing device according to claim 1,
wherein the determination unit determines whether or not a target area which is equal to or less than a reference distance from the one of the plurality of contact points includes the any other contact point, and
wherein, in the case where the determination unit determines that the target area includes the any other contact point, the setting unit sets the new target area by setting, as anew reference distance, a distance longer than the reference distance for the target area.

3. The information processing device according to claim 1,
wherein the detection unit is capable of detecting as many contact points as a given upper limit number,
wherein the information processing device comprises:
unit configured to store, in a storage, in the case where the determination unit determines that the target area includes the any other contact point, the any other contact point determined as being included in the target area; and
unit configured to control, in the case where the determination unit determines that the target area includes the any other contact point, the detection unit to detect a new contact point in place of the any other contact point determined as being included in the target area, and
wherein the processing executing unit executes the processing based on the any other contact point determined as being included in the target area, which is stored in the storage.

4. The information processing device according to claim 1, further comprising unit configured to obtain information about a length of the user's finger,
wherein the target area has a size controlled based on the information about the length of the user's finger.

5. The information processing device according to claim 1, further comprising unit configured to obtain information about a length of the user's finger,
wherein an upper limit to a number of times the determination is executed by the determination unit is set based on the information about the length of the user's finger.

6. A method of controlling an information processing device which comprises a touch panel and which detects a plurality of contact points where a user has touched the touchpanel, the method comprising:
executing determination on whether or not a target area, which is set based on one of the plurality of contact points and which includes the one of the plurality of contact points, includes any other contact point out of the plurality of contact points;
setting, in the case where it is determined in the determination that the target area includes the any other contact point, an area that includes an area other than an area formerly set as the target area and that includes the one of the plurality of contact points and the any other contact point, as a new target area based on the one of the plurality of contact points; and
executing, in the case where the determination is executed multiple times, processing based on the one of the plurality of contact points and on each contact point determined as being included in the target area in the determination executed multiple times.

7. A non-transitory computer readable information storage medium storing a program for causing a computer, which comprises a touch panel and which detects a plurality of contact points where a user has touched the touch panel, to function as:
determination unit configured to execute determination on whether or not a target area, which is set based on one of the plurality of contact points and which includes the one of the plurality of contact points, includes any other contact point out of the plurality of contact points;
setting unit configured to set, in the case where the determination unit determines that the target area includes the any other contact point, an area that includes an area other than an area formerly set as the target area and that includes the one of the plurality of contact points and the any other contact point, as a new target area based on the one of the plurality of contact points; and
processing executing unit configured to execute, in the case where the determination unit executes the determination multiple times, processing based on the one of the plurality of contact points and on each contact point determined as being included in the target area in the determination executed multiple times.
